(19) United States
(12) Patent Application Publication
(10) Pub. No.: US 2011/0270698 A1
(43) Pub. Date: Nov. 3, 2011

(54) Providing a Conditional Allowance Within a Virtual Space

(75) Inventor: Sherry Gunther, Calabasas, CA (US)

(73) Assignee: Masher Media Inc., Calabasas, CA (US)

(21) Appl. No.: 12/772,796

(22) Filed: May 3, 2010

(51) Int. Cl. G06Q 20/00; G06Q 40/00; G06Q 50/00; G06Q 30/00; G06Q 10/00

(52) U.S. Cl. 705/26.1; 705/30; 705/40; 705/44

(57) ABSTRACT

A conditional allowance may be provided in a virtual space. Disbursement of the conditional allowance may be contingent upon fulfillment of disbursement requirements. For example, a funds recipient such as a child may receive funds from a funds provider such as a parent if the child has fulfilled various duties assigned by the parent and/or achieved certain goals designated by the parent. Such funds may be utilized by the child to purchase virtual goods within a virtual space.

### FIELD OF THE INVENTION

The invention relates to allowing a parent to provide a conditional allowance to a child within a virtual space to induce the child to fulfill one or more requirements established by the parent.

### BACKGROUND OF THE INVENTION

Parents often attempt various approaches to motivate their children, for example, to perform certain chores or to achieve certain goals. One approach is to provide a monetary allowance to the children as a reward for completing chores or achieving goals. In order to provide the greatest motivation to the children, however, a motivational reward should be in line with the children's interests.

Online communities, such as virtual worlds and other virtual spaces, continue to gain in popularity among the general population and particularly among children. Virtual goods including such things as digital gifts and digital clothing for avatars may be purchased within many online communities and are often greatly prized by children. Parents, however, may be reluctant to provide funds for their children to purchase virtual goods.

### SUMMARY

One aspect of the invention relates to a system that may be configured to allow a funds provider to provide a conditional allowance to a funds recipient within a virtual space. The system may be implemented in the context of a variety of different funds provider-funds recipient relationships such as, for example, a parent and a child, a manager and an employee, and/or a teacher and a student. For illustrative purposes and by way of non-limiting example, however, the present technology is described herein in the context of a funds recipient being a child who is a user of a virtual space and a funds provider being a parent of the child.

The system may allow a parent to induce a child to fulfill one or more requirements established by the parent by providing a conditional allowance within an environment of particular interest to the child such as within a virtual space. The child may apply funds received as the conditional allowance to make purchases within the virtual space. Such funds may include real-world currencies (e.g., U.S. dollars), virtual currencies (e.g., MicroBucks and/or MiniBucks), and/or any other medium of exchange. The system may allow the parent to establish, modify, and/or track requirements that must be fulfilled in order for the child receive such funds. The system may facilitate an allowance fund in which the parent deposits funds, and/or a transactional fund that the child may access to make purchases within the virtual space. Disbursement of funds to the transactional fund may be contingent upon the child fulfilling one or more requirements established by the parent. Funds may be disbursed to the transactional fund (as real-world currency, virtual currency, and/or any other medium of exchange) from the allowance fund, a bank account associated with the parent, a credit card associated with the parent, an internet pay-anyone account, and/or any other source of funds.

Purchases within the virtual space may include purchases of virtual goods. Virtual goods may be non-physical objects that can be purchased for use in online communities, online games, virtual worlds, and other virtual spaces. Virtual goods may include, for example, such things as digital gifts, digital clothing for avatars, virtual real estate, virtual neighborhoods, virtual objects that are usable by an avatar within a virtual space, virtual objects that are controllable by a user within a virtual space, and/or any other virtual item. Virtual goods may be classified as services (i.e., virtual services) instead of goods. In exemplary implementations, purchases within the virtual space may include purchases of attributes, abilities, and/or characteristics associated with avatars of the virtual space such as special powers, dance moves, expressions (emotes), and/or any other aspect associated with avatars of the virtual space. Transactions in which virtual goods are bought and/or sold may be referred to as microtransactions.

In some implementations, the system may include one or more of one or more virtual space servers and/or other components. The system 100 may include one or more virtual machines (not depicted in FIG. 1) that perform the same or similar functions attributed herein to the virtual space servers 102, in accordance with some implementations. Children, parents, and/or other users may interface with the system via client computing platforms. The components of the system and/or client computing platforms may be operatively linked via one or more electronic communication links. For example, such electronic communication links may be established, at least in part, via a network. The network may include the Internet and/or other networks.

A given client computing platform may include one or more processors configured to execute computer program modules. The computer program modules may be configured to enable one or more children, parents, and/or other users associated with the given client computing platform to interface with system and/or provide other functionality attributed herein to client computing platforms. By way of non-limiting example, the given client computing platform may include one or more of a desktop computer, a laptop computer, a handheld computer, a portable digital assistant (PDA), a NetBook, a Smartphone, and/or other computing platforms.

The virtual space servers may comprise electronic storage, one or more processors, and/or other components. Electronic storage may comprise electronic storage media that electronically stores information. The processor(s) may be configured to provide information processing capabilities in virtual space servers. The processor(s) may be configured to execute one or more computer program modules. The one or more computer program modules may include one or more of a funds provider interface module, an allowance fund module, a transactional fund module, an allowance disbursement module, a tasks management module, a goals management module, a behavior monitoring module, and/or other modules.

The funds provider interface module may be configured to generate a user interface that is provided to funds providers. For example, the user interface may be presented to funds providers via a web site that is hosted by the virtual space server(s). The web site may be accessible by funds providers via a web browser (or other client application) that is executable on the client computing platforms. The user interface may be presented to funds providers on the client computing platforms via other client applications (e.g., widgets, gadgets, Smartphone apps, etc.). The functionality attributed herein to the user interface provided by the funds provider interface module may be accomplished via some other mechanism. For example, funds providers may communicate with the funds provider interface module via text message, instant message, email, telephone, and/or other communications platforms to interact with the funds provider interface module in the manner described.

The user interface provided by the funds provider interface module may be configured to receive user inputs, selections, commands, and/or other communication that allow a funds provider (e.g., parent) to access and/or manipulate information, parameters, settings, and/or other attributes associated with one or more modules of the processor(s). For example, via the user interface provided by the funds provider interface module, a parent may establish new disbursement requirements, modify existing disbursement requirements, indicate fulfillment of disbursement requirements (which is described further below in connection with the allowance disbursement module), and/or otherwise interact with the system. At least some of the other potential functionalities associated with the funds provider interface module are described further in connection with one or more other modules described herein.

The allowance fund module may be configured to manage an allowance fund. The allowance fund may contain funds received from the funds provider (e.g., parent). According to some implementations, funds received as real-world currency by the allowance fund module may be converted to virtual currency and/or any other medium of exchange. Such funds may be received by the allowance fund by way of credit card payment, direct deposit, and/or any other method for transferring funds. The allowance fund may include an account maintained by a party that owns or manages the system. The allowance fund may include an account maintained by a third party such as a bank or other financial institution. The allowance fund module may charge a credit card or bank account automatically. For example, the allowance fund module may charge a credit card or bank account on a predetermined schedule for a predetermined amount of money. The allowance fund module may charge a credit card or bank account when funds fall below a threshold amount. Funds may be periodically deducted from the allowance fund as a subscription fee of the virtual space. The allowance fund module may provide an allowance fund alert to the funds provider (e.g., parent) such as when the amount of funds contained in the allowance fund falls below a threshold amount. The funds provider interface module may be utilized to set and/or adjust various parameters associated with the allowance fund module such as credit card information, bank account information, automatic credit card or bank account charging criteria (e.g., periodicity, amount, and/or other criteria), allowance fund alert settings (e.g., below a certain threshold, above a certain threshold, and/or other alert settings), and/or other parameters associated with the allowance fund module.

The transactional fund module may be configured to manage a transactional fund. The transactional fund may contain funds available to a funds recipient (e.g., child) for purchasing virtual goods within a virtual space. Funds contained in the transactional fund may include real-world currency, virtual currency, and/or any other medium of exchange. Such funds may be received from the allowance account managed by the allowance fund module, and/or be received by the funds provider (e.g., parent) via credit card payment, direct deposit, and/or any other method for transferring funds. The transactional fund may include an account maintained by a party that owns or manages the system. The transactional fund may include an account maintained by a third party such as a bank or other financial institution. Funds may be periodically deducted from the transactional fund as a subscription fee of the virtual space. The transactional fund module may provide a transactional fund alert to the funds provider (e.g., parent) and/or the funds recipient (e.g., child) such as when the amount of funds contained in the transactional fund falls below a threshold amount. The funds provider interface module may be utilized to set and/or adjust various parameters associated with the transactional fund module such as credit card information, bank account information, automatic credit card or bank account charging criteria, transactional fund alert settings, and/or other parameters associated with the transactional fund module.

The allowance disbursement module may be configured to facilitate disbursement of funds to the transactional fund. Such funds may be disbursed or transferred from the allowance account managed by the allowance fund module. Such funds may be disbursed or transferred from a bank account associated with the funds provider (e.g., parent), a credit card associated with the funds provider (e.g., parent), and/or any other funding sources associated with the funds provider (e.g., parent). According to various implementations, the disbursed funds may include real-world currency, virtual currency, and/or any other medium of exchange. The disbursement may be based at least in part on fulfillment by the funds recipient (e.g., child) of one or more disbursement requirements established by the funds provider (e.g., parent).

A disbursement requirement may be associated with a real-world action by the funds recipient (e.g., child). For example, a disbursement requirement may include completion of chore or other task. A disbursement requirement may be associated with a virtual action by the funds recipient (e.g., child) within the virtual space. For example, a disbursement requirement may include certain behavioral constraints within the virtual space such as interacting or not interacting with certain other users' avatars. A disbursement requirement may include completing certain activities online and/or within the virtual space (e.g., learning or educational activities). A disbursement requirement may include receiving certification online and/or in the virtual space for an activity accomplished in the real world (e.g., a teacher certifying receipt of homework, a certain grade on an exercise, and/or other activities). A disbursement requirement may include other activities.

The disbursement of funds to the transactional fund may occur when disbursement requirements are fulfilled by the funds recipient (e.g., child). According to some implementations, the funds provider (e.g., parent) can trigger the disbursement via the funds provider interface module such as when disbursement requirements are fulfilled by the funds recipient (e.g., child). The disbursement of funds to the transactional fund may occur at a predetermined time such as semi-weekly, weekly, bi-weekly, end-of-semester, and/or any other predetermined time. Certain disbursement requirements may be associated with a time period preceding the predetermined time. For example, certain chores may be required to be completed during the week preceding a predetermined disbursement time in order for disbursement to occur. In some implementations, the disbursement of funds to the transactional account may occur automatically if a funds provider (e.g., parent) fails to approve or disapprove of the disbursement within a predetermined window of time. Some disbursements may be one-time disbursements such as, for example, in response to certain achievements (e.g., athletic achievement, boy or girl scouting achievement, etc.).

According to some implementations, the allowance disbursement module may be configured to disburse funds to individual funds recipients based on fulfillment of one or more disbursement requirements of a group of funds recipients. By way of non-limiting example, a parent of two or more children may require the two or more children to perform a collaborative task as a disbursement requirement. Upon completion of the collaborative task, individual ones of the two or more children may receive funds in transactional funds corresponding to the two or more children. The one or more disbursement requirements may be established by a single funds provider, by a committee of funds providers, and/or by any other entity.

The allowance disbursement module may be configured to provide a disbursement alert to the funds provider (e.g., parent) prompting the funds provider (e.g., parent) to indicate whether the disbursement requirements have been fulfilled by the funds recipient (e.g., child). Such indication may be made via the funds provider interface module. The disbursement alert may be provided at a predetermined time. The disbursement alert may be provided in response to a request by the funds recipient (e.g., child). For example, when a child completes a chore, the child may provide an indication within the virtual space that the chore is complete resulting in the disbursement alert being provided to the parent. The funds provider interface module may be utilized to set and/or adjust various parameters associated with the allowance disbursement module such as disbursement schedule, disbursement amounts, disbursement alert settings, and/or other parameters associated with the allowance disbursement module.

The tasks management module may be configured to track assignment and completion of tasks assigned by the funds provider (e.g., parent) to the funds recipient (e.g., child). Completion of one or more of the tasks may be one or more of the disbursement requirements associated with the allowance disbursement module. Examples of tasks may include various household chores and/or other duties assigned by the funds provider (e.g., parent). The funds provider interface module may be utilized in conjunction with the tasks management module in order to assign tasks and indicate completion of those tasks.

The goals management module may be configured to track one or more goals designated by the funds provider (e.g., parent) for the funds recipient (e.g., child). Obtainment of one or more of the goals may be one or more of the disbursement requirements associated with the allowance disbursement module. Examples of goals may include good grades, boy or girl scout advancement, sports achievement, achievements in programs and/or projects accessible within the virtual space, and/or other goals obtainable by the funds recipient (e.g., child). The funds provider interface module may be utilized in conjunction with the goals management module in order to designate goals and indicate completion of those goals.

The behavior monitoring module may be configured to determine whether the funds recipient (e.g., child) has adhered to one or more usage guidelines of the virtual space established by the funds provider (e.g., parent). Adherence to one or more of the usage guidelines may be one or more of the disbursement requirements associated with the allowance disbursement module. Examples of usage guidelines may include a length of time spent participating in the virtual space, interacting or not interacting with certain other users' avatars, purchasing or not purchasing certain virtual goods, and/or any other usage guideline of the virtual space. The funds provider interface module may be utilized in conjunction with the behavior monitoring module in order to designate usage guidelines and determine whether such usage guidelines have been adhered to by the funds recipient (e.g., child).

Another aspect of the invention relates to a method for allowing a funds provider to provide a conditional allowance to a funds recipient within a virtual space. The method may be implemented in the context of a variety of different funds provider-funds recipient relationships such as, for example, a parent and a child, a manager and an employee, and/or a teacher and a student. In some implementations, the method may be accomplished with one or more additional operations not described, and/or without one or more of the operations discussed. Additionally, the order in of the operations of the method are not intended to be limiting.

At one operation, funds are stored in a transactional fund. The transactional fund may contain funds available to a funds recipient such as a child for purchasing virtual goods within a virtual space. Virtual goods may include non-physical objects that can be purchased for use in online communities, online games, virtual worlds, and other virtual spaces. Virtual goods may include, for example, such things as digital gifts, digital clothing for avatars, virtual real estate, and/or any other virtual item. According to exemplary implementations, the transactional fund module may be executed to perform this operation.

At another operation, funds are disbursed to the transactional fund. The disbursement may be based at least in part on fulfillment by the funds recipient (e.g., child) of one or more disbursement requirements established by the funds provider (e.g., parent). Such funds may be disbursed or transferred from the allowance account managed by the allowance fund module. Such funds may be disbursed or transferred from a bank account associated with the funds provider (e.g., parent), a credit card associated with the funds provider (e.g., parent), and/or any other funding sources associated with the funds provider (e.g., parent). A disbursement requirement may be associated with a real-world action by the funds recipient (e.g., child). A disbursement requirement may be associated with an online action and/or a virtual action by the funds recipient (e.g., child) performed online and/or within the virtual space. According to exemplary implementations, the allowance disbursement module may be executed to perform this operation.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that may be configured to allow a funds provider to provide a conditional allowance to a funds recipient within a virtual space, according to exemplary implementations.

FIG. 2 illustrates a method for allowing a funds provider to provide a conditional allowance to a funds recipient within a virtual space, according to exemplary implementations.

### DETAILED DESCRIPTION

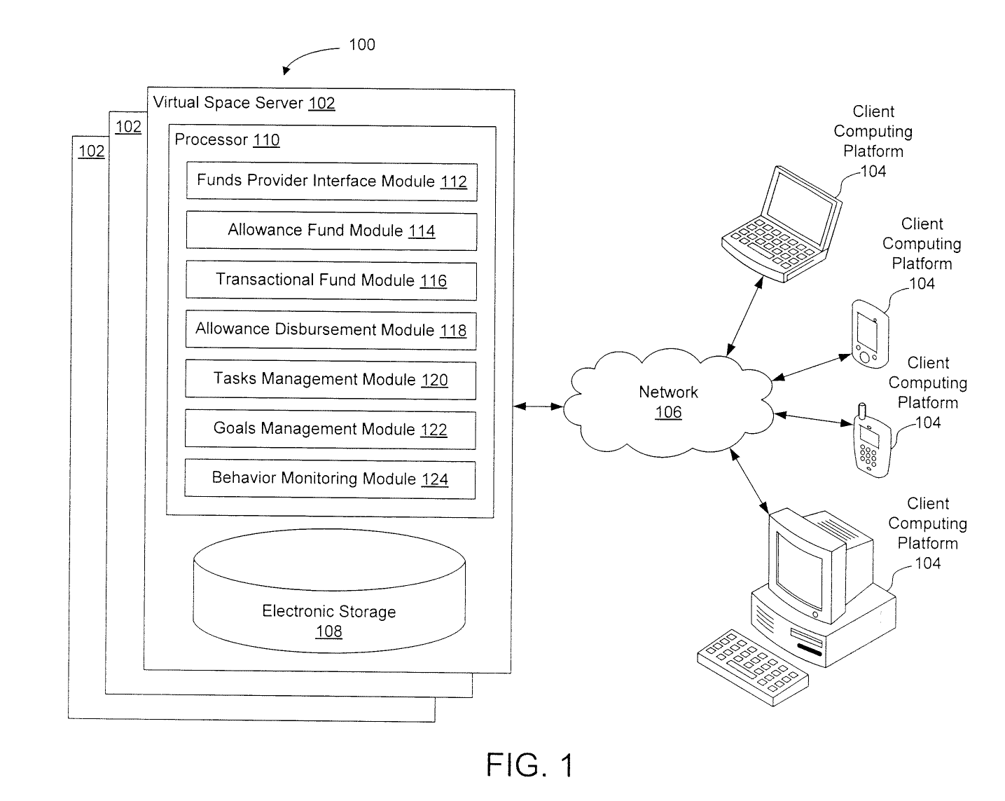

FIG. 1 illustrates a system 100 that may be configured to allow a funds provider to provide a conditional allowance to a funds recipient within a virtual space. The system 100 may be implemented in the context of a variety of different funds provider-funds recipient relationships such as, for example, a parent and a child, a manager and an employee, and/or a teacher and a student. For illustrative purposes and by way of non-limiting example, however, the present technology is described herein in the context of a funds recipient being a child who is a user of a virtual space and a funds provider being a parent of the child.

The system 100 may allow a parent to induce a child to fulfill one or more requirements established by the parent by providing a conditional allowance within an environment of particular interest to the child such as within a virtual space. The child may apply funds received as the conditional allowance to make purchases within the virtual space. Such funds may include real-world currencies (e.g., U.S. dollars), virtual currencies (e.g., MicroBucks and/or MiniBucks), and/or any other medium of exchange. The system 100 may allow the parent to establish, modify, and/or track requirements that must be fulfilled in order for the child receive such funds. The system 100 may facilitate an allowance fund in which the parent deposits funds, and/or a transactional fund that the child may access to make purchases within the virtual space. Disbursement of funds to the transactional fund may be contingent upon the child fulfilling one or more requirements established by the parent. Funds may be disbursed to the transactional fund (as real-world currency, virtual currency, and/or any other medium of exchange) from the allowance fund, a bank account associated with the parent, a credit card associated with the parent, an internet pay-anyone account, and/or any other source of funds.

Purchases within the virtual space may include purchases of virtual goods. Virtual goods may be non-physical objects that can be purchased for use in online communities, online games, virtual worlds, and other virtual spaces. Virtual goods may include, for example, such things as digital gifts, digital clothing for avatars, virtual real estate, virtual neighborhoods, virtual objects that are usable by an avatar within a virtual space, virtual objects that are controllable by a user within a virtual space, and/or any other virtual item. Virtual goods may be classified as services (i.e., virtual services) instead of goods. In exemplary implementations, purchases within the virtual space may include purchases of attributes, abilities, and/or characteristics associated with avatars of the virtual space such as special powers, dance moves, expressions (emotes), and/or any other aspect associated with avatars of the virtual space. Transactions in which virtual goods are bought and/or sold may be referred to as microtransactions.

In some implementations, system 100 may include one or more of one or more virtual space servers 102 and/or other components. The system 100 may include one or more virtual machines (not depicted in FIG. 1) that perform the same or similar functions attributed herein to the virtual space servers 102, in accordance with some implementations. Children, parents, and/or other users may interface with system 100 via client computing platforms 104. The components of system 100 and/or client computing platforms 104 may be operatively linked via one or more electronic communication links. For example, such electronic communication links may be established, at least in part, via a network 106. The network 106 may include the Internet and/or other networks. It will be appreciated that this is not intended to be limiting, and that the scope of this disclosure includes implementations in which virtual space servers 102 and/or client computing platforms 104 are operatively linked via some other communication media.

A given client computing platform 104 may include one or more processors configured to execute computer program modules. The computer program modules may be configured to enable one or more children, parents, and/or other users associated with the given client computing platform 104 to interface with system 100 and/or provide other functionality attributed herein to client computing platforms 104. By way of non-limiting example, the given client computing platform 104 may include one or more of a desktop computer, a laptop computer, a handheld computer, a portable digital assistant (PDA), a NetBook, a Smartphone, and/or other computing platforms.

The virtual space servers 102 may comprise electronic storage 108, one or more processors 110, and/or other components. Electronic storage 108 and processors 110 are described in further detail here. The processors 110 may be configured to execute computer program modules via one or more of hardware, software, and/or firmware to provide, or serve, one or more virtual spaces.

As used herein, a virtual space may comprise a simulated space (e.g., a physical space) instanced on a server (e.g., virtual space servers 102) that may be accessible by a client (e.g., client computing platforms 104) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Within the virtual space provided by virtual space servers 102, avatars associated with the users may be controlled by the users to interact with each other. As used herein, the term “avatar” may refer to an object (or group of objects) present in the virtual space that represents an individual user. The avatar may be controlled by the user with which it is associated. The avatars may interact with each other by physical interaction within the instanced virtual space, through text chat, through voice chat, and/or through other interactions. The avatar associated with a given user may be created and/or customized by the given user. The avatar may be associated with an “inventory” of virtual goods and/or currency such as that contained in a transactional fund that the user can use (e.g., by manipulation of the avatar and/or the items) within the virtual space.

Electronic storage 108 may comprise electronic storage media that electronically stores information. The electronic storage media of electronic storage 108 may include one or both of system storage that is provided integrally (i.e., substantially non-removable) with virtual space servers 102 and/or removable storage that is removably connectable to virtual space servers 102 via, for example, a port (e.g., a USB port, a firewire port, etc.) or a drive (e.g., a disk drive, etc.). Electronic storage 108 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 108 may store software algorithms, information determined by processor 110, information received from virtual space servers 102, information received from client computing platforms 104, and/or other information that enables virtual space servers 102 to function properly.

Processor(s) 110 may be configured to provide information processing capabilities in virtual space servers 102. As such, processor 110 may include one or more of a digital processor, an analog processor, a digital circuit designed to process information, an analog circuit designed to process information, a state machine, and/or other mechanisms for electronically processing information. Although processor 110 is shown in FIG. 1 as a single entity, this is for illustrative purposes only. In some implementations, processor 110 may include a plurality of processing units. These processing units may be physically located within the same device, or processor 110 may represent processing functionality of a plurality of devices operating in coordination (e.g., the virtual space servers 102 and/or the client computing platforms 104).

As is shown in FIG. 1, processor 110 may be configured to execute one or more computer program modules. The one or more computer program modules may include one or more of a funds provider interface module 112, an allowance fund module 114, a transactional fund module 116, an allowance disbursement module 118, a tasks management module 120, a goals management module 122, a behavior monitoring module 124, and/or other modules. Processor 110 may be configured to execute modules 112, 114, 116, 118, 120, 122, and/or 124 by software; hardware; firmware; some combination of software, hardware, and/or firmware; and/or other mechanisms for configuring processing capabilities on processor 110.

It should be appreciated that although modules 112, 114, 116, 118, 120, 122, and 124 are illustrated in FIG. 1 as being co-located within a single processing unit, in implementations in which processor 110 includes multiple processing units, one or more of modules 112, 114, 116, 118, 120, 122, and/or 124 may be located remotely from the other modules. In implementations in which virtual space servers 102 and client computing platforms 104 operate in a coordinated manner to provide the functionality described herein with respect to processor 110, some or all of the functionality attributed to one or more of 112, 114, 116, 118, 120, 122, and/or 124 may be provided by the modules executed on processors of the client computing platforms 104. The description of the functionality provided by the different modules 112, 114, 116, 118, 120, 122, and/or 124 described below is for illustrative purposes, and is not intended to be limiting, as any of modules 112, 114, 116, 118, 120, 122, and/or 124 may provide more or less functionality than is described. For example, one or more of modules 112, 114, 116, 118, 120, 122, and/or 124 may be eliminated, and some or all of its functionality may be provided by other ones of modules 112, 114, 116, 118, 120, 122, and/or 124. As another example, processor 110 may be configured to execute one or more additional modules that may perform some or all of the functionality attributed below to one of modules 112, 114, 116, 118, 120, 122, and/or 124.

The funds provider interface module 112 may be configured to generate a user interface that is provided to funds providers. For example, the user interface may be presented to funds providers via a web site that is hosted by server 102. The web site may be accessible by funds providers via a web browser (or other client application) that is executable on client computing platforms 104. The user interface may be presented to funds providers on client computing platforms 104 via other client applications (e.g., widgets, gadgets, Smartphone apps, etc.). The functionality attributed herein to the user interface provided by funds provider interface module 112 may be accomplished via some other mechanism. For example, funds providers may communicate with funds provider interface module 112 via text message, instant message, email, telephone, and/or other communications platforms to interact with funds provider interface module 112 in the manner described.

The user interface provided by funds provider interface module 112 may be configured to receive user inputs, selections, commands, and/or other communication that allow a funds provider (e.g., parent) to access and/or manipulate information, parameters, settings, and/or other attributes associated with one or more modules of the processors 110. For example, via the user interface provided by funds provider interface module 112, a parent may establish new disbursement requirements, modify existing disbursement requirements, indicate fulfillment of disbursement requirements (which is described further below in connection with the allowance disbursement module 118), and/or otherwise interact with system 100. At least some of the other potential functionalities associated with the funds provider interface module 112 are described further in connection with one or more of the modules 114, 116, 118, 120, 122, and/or 124.

The allowance fund module 114 may be configured to manage an allowance fund. The allowance fund may contain funds received from the funds provider (e.g., parent). According to some implementations, funds received as real-world currency by the allowance fund module 114 may be converted to virtual currency and/or any other medium of exchange. Such funds may be received by the allowance fund by way of credit card payment, direct deposit, and/or any other method for transferring funds. The allowance fund may include an account maintained by a party that owns or manages the system 100. The allowance fund may include an account maintained by a third party such as a bank or other financial institution. The allowance fund module 114 may charge a credit card or bank account automatically. For example, the allowance fund module 114 may charge a credit card or bank account on a predetermined schedule for a predetermined amount of money. The allowance fund module 114 may charge a credit card or bank account when funds fall below a threshold amount. Funds may be periodically deducted from the allowance fund as a subscription fee of the virtual space. The allowance fund module 114 may provide an allowance fund alert to the funds provider (e.g., parent) such as when the amount of funds contained in the allowance fund falls below a threshold amount. The funds provider interface module 112 may be utilized to set and/or adjust various parameters associated with the allowance fund module 114 such as credit card information, bank account information, automatic credit card or bank account charging criteria (e.g., periodicity, amount, and/or other criteria), allowance fund alert settings (e.g., below a certain threshold, above a certain threshold, and/or other alert settings), and/or other parameters associated with the allowance fund module 114.

The transactional fund module 116 may be configured to manage a transactional fund. The transactional fund may contain funds available to a funds recipient (e.g., child) for purchasing virtual goods within a virtual space. Funds contained in the transactional fund may include real-world currency, virtual currency, and/or any other medium of exchange. Such funds may be received from the allowance account managed by the allowance fund module 114, and/or be received by the funds provider (e.g., parent) via credit card payment, direct deposit, and/or any other method for transferring funds. The transactional fund may include an account maintained by a party that owns or manages the system 100. The transactional fund may include an account maintained by a third party such as a bank or other financial institution. Funds may be periodically deducted from the transactional fund as a subscription fee of the virtual space. The transactional fund module 116 may provide a transactional fund alert to the funds provider (e.g., parent) and/or the funds recipient (e.g., child) such as when the amount of funds contained in the transactional fund falls below a threshold amount. The funds provider interface module 112 may be utilized to set and/or adjust various parameters associated with the transactional fund module 114 such as credit card information, bank account information, automatic credit card or bank account charging criteria, transactional fund alert settings, and/or other parameters associated with the transactional fund module 116.

The allowance disbursement module 118 may be configured to facilitate disbursement of funds to the transactional fund. Such funds may be disbursed or transferred from the allowance account managed by the allowance fund module 114. Such funds may be disbursed or transferred from a bank account associated with the funds provider (e.g., parent), a credit card associated with the funds provider (e.g., parent), and/or any other funding sources associated with the funds provider (e.g., parent). According to various implementations, the disbursed funds may include real-world currency, virtual currency, and/or any other medium of exchange. The disbursement may be based at least in part on fulfillment by the funds recipient (e.g., child) of one or more disbursement requirements established by the funds provider (e.g., parent).

A disbursement requirement may be associated with a real-world action by the funds recipient (e.g., child). For example, a disbursement requirement may include completion of chore or other task. A disbursement requirement may be associated with a virtual action by the funds recipient (e.g., child) within the virtual space. For example, a disbursement requirement may include certain behavioral constraints within the virtual space such as interacting or not interacting with certain other users' avatars. A disbursement requirement may include completing certain activities online and/or within the virtual space (e.g., learning or educational activities). A disbursement requirement may include receiving certification online and/or in the virtual space for an activity accomplished in the real world (e.g., a teacher certifying receipt of homework, a certain grade on an exercise, and/or other activities). A disbursement requirement may include other activities.

The disbursement of funds to the transactional fund may occur when disbursement requirements are fulfilled by the funds recipient (e.g., child). According to some implementations, the funds provider (e.g., parent) can trigger the disbursement via the funds provider interface module 112 such as when disbursement requirements are fulfilled by the funds recipient (e.g., child). The disbursement of funds to the transactional fund may occur at a predetermined time such as semi-weekly, weekly, bi-weekly, end-of-semester, and/or any other predetermined time. Certain disbursement requirements may be associated with a time period preceding the predetermined time. For example, certain chores may be required to be completed during the week preceding a predetermined disbursement time in order for disbursement to occur. In some implementations, the disbursement of funds to the transactional account may occur automatically if a funds provider (e.g., parent) fails to approve or disapprove of the disbursement within a predetermined window of time. Some disbursements may be one-time disbursements such as, for example, in response to certain achievements (e.g., athletic achievement, boy or girl scouting achievement, etc.).

According to some implementations, the allowance disbursement module 118 may be configured to disburse funds to individual funds recipients based on fulfillment of one or more disbursement requirements of a group of funds recipients. By way of non-limiting example, a parent of two or more children may require the two or more children to perform a collaborative task as a disbursement requirement. Upon completion of the collaborative task, individual ones of the two or more children may receive funds in transactional funds corresponding to the two or more children. The one or more disbursement requirements may be established by a single funds provider, by a committee of funds providers, and/or by any other entity.

The allowance disbursement module 118 may be configured to provide a disbursement alert to the funds provider (e.g., parent) prompting the funds provider (e.g., parent) to indicate whether the disbursement requirements have been fulfilled by the funds recipient (e.g., child). Such indication may be made via the funds provider interface module 112. The disbursement alert may be provided at a predetermined time. The disbursement alert may be provided in response to a request by the funds recipient (e.g., child). For example, when a child completes a chore, the child may provide an indication within the virtual space that the chore is complete resulting in the disbursement alert being provided to the parent. The funds provider interface module 112 may be utilized to set and/or adjust various parameters associated with the allowance disbursement module 118 such as disbursement schedule, disbursement amounts, disbursement alert settings, and/or other parameters associated with the allowance disbursement module 118.

The tasks management module 120 may be configured to track assignment and completion of tasks assigned by the funds provider (e.g., parent) to the funds recipient (e.g., child). Completion of one or more of the tasks may be one or more of the disbursement requirements associated with the allowance disbursement module 118. Examples of tasks may include various household chores and/or other duties assigned by the funds provider (e.g., parent). The funds provider interface module 112 may be utilized in conjunction with the tasks management module 120 in order to assign tasks and indicate completion of those tasks.

The goals management module 122 may be configured to track one or more goals designated by the funds provider (e.g., parent) for the funds recipient (e.g., child). Obtainment of one or more of the goals may be one or more of the disbursement requirements associated with the allowance disbursement module 118. Examples of goals may include good grades, boy or girl scout advancement, sports achievement, achievements in programs and/or projects accessible within the virtual space, and/or other goals obtainable by the funds recipient (e.g., child). The funds provider interface module 112 may be utilized in conjunction with the goals management module 122 in order to designate goals and indicate completion of those goals.

The behavior monitoring module 124 may be configured to determine whether the funds recipient (e.g., child) has adhered to one or more usage guidelines of the virtual space established by the funds provider (e.g., parent). Adherence to one or more of the usage guidelines may be one or more of the disbursement requirements associated with the allowance disbursement module 118. Examples of usage guidelines may include a length of time spent participating in the virtual space, interacting or not interacting with certain other users' avatars, purchasing or not purchasing certain virtual goods, and/or any other usage guideline of the virtual space. The funds provider interface module 112 may be utilized in conjunction with the behavior monitoring module 124 in order to designate usage guidelines and determine whether such usage guidelines have been adhered to by the funds recipient (e.g., child).

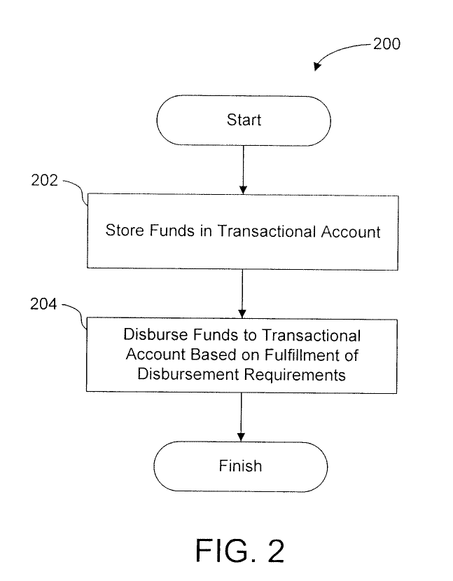

FIG. 2 illustrates a method 200 for allowing a funds provider to provide a conditional allowance to a funds recipient within a virtual space. The method 200 may be implemented in the context of a variety of different funds provider-funds recipient relationships such as, for example, a parent and a child, a manager and an employee, and/or a teacher and a student. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200. According to some implementations, the operations of method 200 may be implemented by one or more virtual machines.

At an operation 202, funds are stored in a transactional fund. The transactional fund may contain funds available to a funds recipient such as a child for purchasing virtual goods within a virtual space. Virtual goods may include non-physical objects that can be purchased for use in online communities, online games, virtual worlds, and other virtual spaces. Virtual goods may include, for example, such things as digital gifts, digital clothing for avatars, virtual real estate, and/or any other virtual item. According to exemplary implementations, the transactional fund module 116 may be executed to perform operation 202.

At an operation 204, funds are disbursed to the transactional fund. The disbursement may be based at least in part on fulfillment by the funds recipient (e.g., child) of one or more disbursement requirements established by the funds provider (e.g., parent). Such funds may be disbursed or transferred from the allowance account managed by the allowance fund module 114. Such funds may be disbursed or transferred from a bank account associated with the funds provider (e.g., parent), a credit card associated with the funds provider (e.g., parent), and/or any other funding sources associated with the funds provider (e.g., parent). A disbursement requirement may be associated with a real-world action by the funds recipient (e.g., child). A disbursement requirement may be associated with an online action and/or a virtual action by the funds recipient (e.g., child) performed online and/or within the virtual space. According to exemplary implementations, the allowance disbursement module 118 may be executed to perform operation 202.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system for a funds provider to provide a conditional allowance to a funds recipient within a virtual space, the system comprising:
one or more computing devices including one or more processors configured to execute computer program modules, the computer program modules comprising:
a transactional fund module configured to manage a transactional fund, the transactional fund containing funds available to the funds recipient for purchasing virtual goods within the virtual space; and
an allowance disbursement module configured to facilitate disbursement of funds to the transactional fund, the disbursement based at least in part on fulfillment by the funds recipient of one or more disbursement requirements established by the funds provider.

2. The system of claim 1, wherein the computer program modules further comprise an allowance fund module configured to manage an allowance fund, the allowance fund containing funds received from the funds provider, and wherein the allowance disbursement module facilitates disbursement of funds from the allowance fund to the transactional fund.

3. The system of claim 1, wherein the funds disbursed to the transactional fund are transferred from one or more of a bank account associated with the funds provider or a credit card associated with the funds provider.

4. The system of claim 1, wherein funds are periodically deducted from the transactional fund as a subscription fee of the virtual space.

5. The system of claim 1, wherein the computer program modules further comprise a tasks management module configured to track assignment and completion of one or more tasks assigned by the funds provider to the funds recipient, completion of at least one of the tasks being at least one of the disbursement requirements.

6. The system of claim 1, wherein the computer program modules further comprise a goals management module configured to track one or more goals designated by the funds provider for the funds recipient, obtainment of at least one of the goals being at least one of the disbursement requirements.

7. The system of claim 1, wherein the computer program modules further comprise a behavior monitoring module configured to determine whether the funds recipient has adhered to one or more usage guidelines of the virtual space established by the funds provider, adherence to at least one of the usage guidelines being at least one of the disbursement requirements.

8. The system of claim 1, wherein at least one disbursement requirement is associated with a real-world action by the funds recipient.

9. The system of claim 1, wherein at least one disbursement requirement is associated with a virtual action by the funds recipient within the virtual space.

10. The system of claim 1, wherein the computer program modules further comprise a funds provider interface module configured to provide an interface configured to receive, from the funds provider, establishment of at least one new disbursement requirement, modification of at least one existing disbursement requirement, or indication of fulfillment of at least one disbursement requirement.

11. The system of claim 1, wherein the disbursement occurs when the one or more disbursement requirements are fulfilled by the funds recipient.

12. The system of claim 1, wherein the disbursement occurs at a predetermined time and when one or more disbursement requirements associated with a time period preceding the predetermined time are fulfilled by the funds recipient.

13. The system of claim 1, wherein the allowance disbursement module is configured to provide a disbursement alert to the funds provider prompting the funds provider to indicate whether the one or more disbursement requirements have been fulfilled by the funds recipient.

14. The system of claim 13, wherein the disbursement alert is provided at a predetermined time.

15. The system of claim 13, wherein the disbursement alert is provided in response to a request by the funds recipient.

16. The system of claim 1, wherein the allowance fund module is configured to provide an allowance fund alert to the funds provider when the amount of funds contained in the allowance fund falls below a threshold amount.

17. The system of claim 1, wherein the transactional fund module is configured to provide a transactional fund alert to one or more of the funds provider or the funds recipient when the amount of funds contained in the transactional fund falls below a threshold amount.

18. The system of claim 1, wherein the funds include virtual funds.

19. A method for allowing a funds provider to provide a conditional allowance to a funds recipient within a virtual space, the method comprising:
executing computer program modules on one or more processors of one or more computing devices, the computer program modules configured to serve the virtual space;
storing funds in a transactional fund, the transactional fund containing funds available to the funds recipient for purchasing virtual goods within the virtual space; and
disbursing funds to the transactional fund, the disbursing based at least in part on fulfillment by the funds recipient of one or more disbursement requirements established by the funds provider.

20. The method of claim 19, further comprising storing funds in an allowance fund, the allowance fund containing funds received from the funds provider, wherein funds are disbursed from the allowance fund to the transactional fund.

21. The method of claim 19, further comprising transferring funds from one or more of a bank account associated with the funds provider or a credit card associated with the funds provider, the transferred funds disbursed to the transactional fund.

22. The method of claim 19, further comprising periodically deducting funds from the transactional fund as a subscription fee of the virtual space.

23. The method of claim 19, further comprising tracking assignment and completion of one or more tasks assigned by the funds provider to the funds recipient, completion of at least one of the tasks being at least one of the disbursement requirements.

24. The method of claim 19, further comprising tracking one or more goals designated by the funds provider for the funds recipient, obtainment of at least one of the goals being at least one of the disbursement requirements.

25. The method of claim 19, further comprising determining whether the funds recipient has adhered to one or more usage guidelines of the virtual space established by the funds provider, adherence to at least one of the usage guidelines being at least one of the disbursement requirements.

26. The method of claim 19, further comprising facilitating establishment by the funds provider of at least one new disbursement requirement.

27. The method of claim 19, further comprising facilitating modification by the funds provider of at least one existing disbursement requirement.

28. The method of claim 19, further comprising facilitating indication by the funds provider of fulfillment of at least one disbursement requirement.

29. The method of claim 19, wherein the disbursing of the funds from the allowance fund to the transactional fund occurs when the one or more disbursement requirements are fulfilled by the funds recipient.

30. The method of claim 19, wherein the disbursing of the funds from the allowance fund to the transactional fund occurs at a predetermined time and when one or more disbursement requirements associated with a given time period are fulfilled by the funds recipient.

31. The method of claim 19, further comprising providing a disbursement alert to the funds provider prompting the funds provider to indicate whether the one or more disbursement requirements have been fulfilled by the funds recipient.

32. The method of claim 19, further comprising providing an allowance fund alert to the funds provider when the amount of funds contained in the allowance fund falls below a threshold amount.

33. The method of claim 19, further comprising providing a transactional fund alert to one or more of the funds provider or the funds recipient when the amount of funds contained in the transactional fund falls below a threshold amount.

34. The method of claim 19, wherein the funds include virtual funds.
